(19) United States
(12) Patent Application Publication
(10) Pub. No.: US 2022/0268741 A1
(43) Pub. Date: Aug. 25, 2022

(54) Probe Arrangement for a Testing System, and Testing System

(71) Applicant: Institut Dr. Foerster GmbH & Co. KG, Reutlingen (DE)

(72) Inventors: Ulf BOERNER, Lichtenstein (DE); Bernhard HEYER, Tuebingen (DE)

(21) Appl. No.: 17/630,957

(22) PCT Filed: Jul. 21, 2020
(86) PCT No.: PCT/EP2020/070561

§ 371 Date: Jan. 28, 2022

(30) Foreign Application Priority Data
Jul. 31, 2019 (DE) 10 2019 211 479.2

(51) Int. Cl. G01N 29/22; G01N 29/24; G01N 29/265; G01N 29/28

(52) U.S. Cl. CPC G01N 29/225; G01N 29/24; G01N 29/265; G01N 29/28

(57) ABSTRACT

A probe arrangement for a testing system includes a base carrier that defines a longitudinal direction, which can be oriented parallel to a testing direction, and a transverse direction, which can be oriented perpendicularly to the testing direction. The base carrier carries a plurality of probe holders which are arranged next to one another in a row in the transverse direction. Each probe holder has a first probe region, which is equipped with at least one first probe, and a second probe region, which is equipped with at least one second probe. Each probe region defines an effective testing width such that, during relative movement of the test subject with respect to the probe arrangement along the testing direction through the probe region, a testing track having the effective testing width can be tested in a gap-free manner. The first probe region and the second probe region are arranged so as to be offset in relation to one another parallel to the longitudinal direction and parallel to the transverse direction such that a first testing track covered by the first probe region transitions on one side in a gap-free manner into a second testing track covered by the second probe region of the same probe holder, and transitions on the opposite side in a gap-free manner into a second testing track covered by a second probe region of a directly adjacent probe holder.

### FIELD OF APPLICATION

The invention relates to a probe arrangement for a testing system for non-destructive material testing involving relative movement of a test specimen with respect to the probe arrangement along a testing direction, and to a testing system. A preferred area of application is probe arrangements for ultrasonic testing systems.

### BACKGROUND

Ultrasonic testing is an acoustic method for detecting material defects, so-called discontinuities, and for determining component dimensions by means of ultrasound. It is one of the non-destructive testing methods. In non-destructive material testing with ultrasound (US), the sound is transmitted from a probe to the test specimen via a coupling medium, e.g. a liquid layer. The transmission of the ultrasonic waves carrying the information about the state of the test material from the test specimen to the receiving probe also generally takes place via the same coupling medium. The term “probe” is understood here to mean a handling unit in which one or more ultrasonic transducers are installed. The ultrasonic transducer itself is the element which converts the electrical signal into a sound signal (acoustic signal) or a sound signal into an electrical signal. In most cases, the sound-emitting and sound-receiving ultrasonic transducers are combined in a probe. If these are separate transmitters and receivers, they are also referred to as transmit-receive probes or TR probes. These are preferred, for example, when a high near-zone resolution capability is required. If the same ultrasonic transducer is used for transmitting and receiving, the term “pulse echo probes” is used.

For the testing of large-area products, for example of plates in steelworks, use is often made nowadays of ultrasonic testing systems which have probe arrangements with a multiplicity of probes and which operate in such a way that a relative movement of a test specimen with respect to the probe arrangement along a testing direction is employed. A probe arrangement has a base carrier, which base carrier defines a longitudinal direction, which can be oriented parallel to the testing direction, and a transverse direction, which can be oriented perpendicularly to the testing direction, and which base carrier carries a plurality of probe holders, which are arranged next to one another in a straight row in the transverse direction. One or more probes are accommodated in each probe holder.

The article “Betriebliche Erfahrungen mit einer neuen Ganztafel-Ultraschallprüfanlage” [Operational Experience with a New Full Plate Ultrasonic Testing System] by A. Weber et al., DGZfP Annual Meeting 2013—Di.2.B.2, pages 1 to 8, describes a full-plate ultrasonic testing system, which is arranged in a rolling mill directly downstream of the cooling bed in the inlet to the shear section. A total of 76 pneumatically individually controlled probe holders are installed in the ultrasonic testing system described. TR probes with a nominal frequency of 5 MHz are used. The multiple oscillators used have a width of 50 mm and are divided 4 times, resulting in 304 test channels to be processed individually. The probe holders are installed in two surface testing carriages arranged one behind the other in the testing direction and offset with respect to one another in the transverse direction by one probe width. According to the article, it is thereby possible to achieve full surface testing (100% testing).

German Laid Open Application DE 34 42 751 A1 discloses an ultrasonic testing system for metal sheets with a plurality of probes which can be adjusted to the metal sheet and which are provided in rows transversely to the conveying direction of the metal sheet and in a plurality of rows one behind the other with an overlap in the conveying direction. Each probe has a transmitter and a receiver.

### PROBLEM AND SOLUTION

The problem addressed by the invention is that of providing a probe arrangement for a testing system for non-destructive material testing involving relative movement of a test specimen with respect to the probe arrangement, which probe arrangement allows gap-free surface testing, while being of simple and low-cost construction.

To solve this problem, the invention provides a probe arrangement having the features of the independent claim. Advantageous embodiments are specified in the dependent claims. The wording of all the claims makes reference to the content of the description.

The probe arrangement is provided for a testing system which is to be used for non-destructive material testing, in which a test specimen is moved with respect to the probe arrangement along a testing direction relative to the testing arrangement. The relative movement can be achieved by arranging the probe arrangement in a stationary manner during testing and moving the test specimen parallel to the testing direction. It is also possible for the test specimen to be at rest during testing and for only the probe arrangement to be moved parallel to the testing direction. It is also possible for both the test specimen and the probe arrangement to be moved parallel to the testing direction during testing.

The testing arrangement comprises a base carrier, which base carrier defines a longitudinal direction, which can be oriented parallel to the testing direction, and a transverse direction, which can be oriented perpendicularly to the testing direction. The base carrier carries a plurality of probe holders, which are arranged next to one another in a row in the transverse direction. During testing, the multiplicity of probe holders is intended to cover as far as possible the entire width of the surface, that is to say with as small as possible untested side edges. Therefore, such probe arrangements are also referred to as surface testing carriages. In order to improve the possibilities for maintenance and reduce the downtimes of the roller table, surface testing carriages can usually be moved in the transverse direction between a testing position suitable for testing and a service position outside the movement path of a test specimen.

Each probe holder has a holding structure which receives the probes, which are as a rule exchangeable, and holds them in the required relative spatial arrangement with respect to one another at the desired positions.

Each of the probe holders has a first probe region, which is equipped with at least one first probe, and a second probe region, which is equipped with at least one second probe. Each of the probe regions defines an effective testing width in such a way that, during relative movement of the test specimen with respect to the probe arrangement parallel to the testing direction through the probe region, a testing track having an effective testing width can be tested in a gap-free manner. The first probe region and the second probe region of one and the same probe holder are arranged so as to be offset with respect to one another both parallel to the longitudinal direction and parallel to the transverse direction. The offset arrangement is configured in such a way that a first testing track covered by the first probe region of a probe holder merges on one side in a gap-free manner into a second testing track covered by the second probe region of the same probe holder, and merges on the opposite side in a gap-free manner into a second testing track covered by a second probe region of a directly adjacent probe holder. Here, a gap-free transition is understood to mean that there is no testing gap in the region between the testing tracks which merge into one another in a gap-free manner, that is to say no region in which testing sensitivity drops below a minimum testing sensitivity which can be predetermined in an application-specific manner. Thus, a testing sensitivity which is sufficient for the testing task is also provided in the transitional region, and therefore, in principle, all the discontinuities or reflectors sought can also be found in the transitional region between adj acent testing tracks.

With regard to the meaning of the terms discontinuity and fault (or defect) in the context of this application, the following should be noted with reference to the example of ultrasonic testing. In principle, a distinction is made between discontinuities and faults. A discontinuity is any object which has been detected as a reflector for ultrasonic waves during ultrasonic testing. A fault is a reflector which has features (e.g. exceeding a maximum area or frequency of reflectors within an area inter alia) which have been defined as not permissible according to official test standards or individual agreements. Not every discontinuity is therefore a fault, but all faults are also discontinuities.

The same also applies to the application of other testing technologies which can be used in principle, for example testing by means of eddy currents (ET) or leakage flux testing (magnetic testing, MT).

By means of the special configuration and arrangement of the probe holders, it is possible to achieve 100% test coverage of a surface which is very wide in the transverse direction with only a single row of probe holders arranged next to one another in the transverse direction. In comparison with conventional solutions, in which two probe arrangements arranged one behind the other in the testing direction and offset with respect to one another in the transverse direction by one probe width were used, one complete probe arrangement can be dispensed with. By eliminating the need to provide, in addition to one probe arrangement, at least one second probe arrangement offset in the longitudinal direction, the accessibility of all the components of the probe arrangement is also improved. The “footprint” of the overall arrangement becomes smaller, i.e. less installation space is required in the longitudinal direction. This simplifies integration into existing installation environments, e.g. in production shops. Higher integration of the system can lead to shorter assembly and start-up times. If the testing system also has edge testing carriages for transverse edge testing, more installation space for the movement relative to the test specimen can be made available to these. A further advantage of the claimed invention is that savings in material costs can be achieved. Thus, a probe arrangement can be provided which allows gap-free surface testing, while being of relatively simple and low-cost construction.

Owing to the special construction, it is possible to carry out surface testing with a single row (i.e. with only a single row of probe holders arranged next to one another in the transverse direction) but nevertheless with 100% test coverage.

A corresponding testing system for non-destructive material testing involving relative movement of a test specimen with respect to the probe arrangement along a testing direction is distinguished by the fact that it has only a single probe arrangement according to the claimed invention.

In some embodiments, it is envisaged that the first testing track covered by the first probe region of a probe holder overlaps on one side with the second testing track covered by the second probe region of the same probe holder in a first overlap region, while it overlaps on the opposite side with the second testing track covered by a second probe region of a directly adjacent probe holder in a second overlap region. The extent of the overlap can be selected in such a way that the testing sensitivity in the overlap region is not or is only insignificantly lower than in the central region of a testing track. The width of the overlap regions results from the required minimum detection sensitivity and the physical properties of the probes used. Overlap regions can, for example, have a width which is between 5% and 25%, in particular between 10% and 20%, of the width of the overlapping testing tracks. In addition, in some test standards, specific requirements with respect to overlap regions of individual testing tracks are formulated, for example in such a way that their width should be at least 10% of the width of the overlapping testing tracks.

According to another formulation, one aspect of the invention can also be described as follows. The first and the second testing track of the probe regions of the same probe holder form an overall testing track of the probes accommodated in this probe holder by virtue of the gap-free transition or the overlap in the first overlap region. The width of this overall testing track, which can be referred to as the overall testing width of a probe holder, is greater than the width of the probe holder, measured in the transverse direction, at its widest point.

So that reliable surface testing is also possible in the case of test specimens with relatively uneven surfaces, provision is made in preferred embodiments for the probe holders to be mounted on the main body in such a way that they can be moved individually. In this case, each of the probe holders is preferably mounted in such a way that it can be tilted to a limited extent both in the longitudinal direction and in the transverse direction. As a result, test signal fluctuations due to misalignments and/or excessively large changes in clearance between the probes and the test specimen can be considerably reduced in comparison with a rigid mount. For this purpose, the probe holders can be mounted on suitable suspension means which are inherently mobile, for example on cardanic suspension means or on parallelogram suspension means with additional degrees of tilting freedom. The probe holders and their suspension means can form probe holder assemblies, each of which can be mounted in an individually exchangeable manner as a whole on the base carrier.

In order, on the one hand, to enable each of the probe holders in the row to be individually movable as far as possible without colliding with directly adjacent probe holders and, on the other hand, nevertheless to ensure testing in a gap-free manner in the transverse direction, the spacing between adjacent probe holders in the transverse direction should be selected to be neither too large nor too small.

In some embodiments, a favorable spacing configuration can be achieved by a special shape of the probe holders in the sliding sole region. The sliding soles are those components of the probe holders which are intended to guide the probe holder or the probes over the surface of the test specimen with as constant a spacing as possible (coupling gap) during testing and, if appropriate with the interposition of a coupling medium, to slide along said surface with or without touching contact. The sliding sole region is thus the region of the probe holders on the side which is to face the test specimen.

In some embodiments, the probe holders have, in the sliding sole region, a front section (which leads during testing) and a rear section (which trails during testing), wherein the front and the rear section are offset with respect to one another in the longitudinal direction and in the transverse direction. The front and the rear section can be used to accommodate the corresponding first and second probe regions or parts thereof.

This is a deviation from conventional concepts in which the probe holders have a shape in the sliding sole region which extends substantially in the longitudinal direction or testing direction.

A more or less pronounced step-shaped transition, which results from the offset in the longitudinal and transverse directions, can lie between the front and the rear section, which can each be of substantially rectangular design, optionally with rounded corners. In some embodiments, there is a central section located between the front section and the rear section, wherein the front and the rear section are offset with respect to one another in the longitudinal direction and in the transverse direction, and the central section extends obliquely with respect to the longitudinal direction and to the transverse direction. The front and the rear section can be used at least in part to accommodate the corresponding first and second probe regions, while the required offset in the transverse direction is made possible by means of the obliquely extending central section, which connects the two sections, while at the same time maintaining a sufficient lateral spacing from directly adjacent probe holders.

According to another formulation, a favorable spacing configuration can be achieved in some embodiments in that each of the probe holders has, in the sliding sole region, a shape which extends obliquely with respect to the longitudinal direction and to the transverse direction, in some section or sections or over the entire length.

According to another formulation, the probe arrangement may also be described such that each of the probe holders has, in the sliding sole region, a shape which is substantially point-symmetrical with respect to a center of symmetry located centrally between a front edge and a rear edge and has no mirror symmetry either with respect to the longitudinal direction or with respect to the transverse direction. The shape can be, for example, substantially S-shaped or Z-shaped.

It is possible that in each of the probe regions of a probe holder, that is to say both in a first probe region and in a second probe region, in each case only one probe is accommodated. In this case, the effective testing width of the probe region would be determined by the effective testing width of one probe. In some embodiments, in each of the probe regions there is arranged a probe group having a plurality of probes which are arranged offset with respect to one another in the longitudinal direction and in the transverse direction in such a way that an effective testing width of the probe region is greater than an individual testing width of each of the probes. Within the respective probe region, the probes can be arranged in a “staggered” manner in two or more planes one behind the other. For example, two probes can be arranged next to one another in the transverse direction in one plane, while one probe is provided in a plane offset in the longitudinal direction with respect thereto, which probe covers the testing gap existing between the two said probes with lateral overlap.

A preferred area of application is probe arrangements for ultrasonic testing systems and ultrasonic testing systems equipped therewith. In this case, for example, conventional ultrasound with water gap coupling can be used as the testing technology. Possible ultrasonic probes are, for example, the transmit-receive probes or TR probes mentioned at the outset or pulse-echo probes. An ultrasonic test can also be carried out with probes which have electromagnetic acoustic transducers (EMAT). Possible embodiments are described, for example, in DE 10 2008 054 250 A1 of the applicant and the prior art cited therein. The probes can also operate according to other testing principles. The probes can be, for example, eddy current probes for testing by means of eddy currents (eddy current testing, ET) or leakage flux probes for magnetic leakage flux testing (magnetic testing, MT).

It is thus possible to test metal sheets, or more generally materials or test specimens, using a probe arrangement of the type described here with different sensors, and thus different testing technologies. Depending on the technology selected, it is possible, for example, to implement applications for different testing tasks, based on the material volume (preferably US or EMAT) or the material surfaces (preferably ET or MT).

Further advantages and aspects of the invention will be found in the claims and the following description of preferred exemplary embodiments of the invention, which will be explained below with reference to the figures.

### BRIEF DESCRIPTION OF THE DRAWINGS

FIG. 1 shows a schematic view of parts of an ultrasonic testing system having a probe arrangement according to one exemplary embodiment;

FIGS. 2A and 2B show a plan view and an oblique perspective view, respectively, of components of four probe holders of a probe arrangement lying next to one another in a row;

FIGS. 3A to 3E show different views of three adjacent probe holders of a probe arrangement according to another embodiment; and

FIG. 4 shows schematically an embodiment with parallelogram-shaped probe holders and testing tracks which merge into one another in a gap-free manner but do not overlap.

### DETAILED DESCRIPTION OF THE EXEMPLARY EMBODIMENTS

Aspects of preferred embodiments are described below using the example of ultrasonic testing. Applications with probes operating according to other principles (e.g. eddy current or leakage flux probes) can be implemented in a similar way.

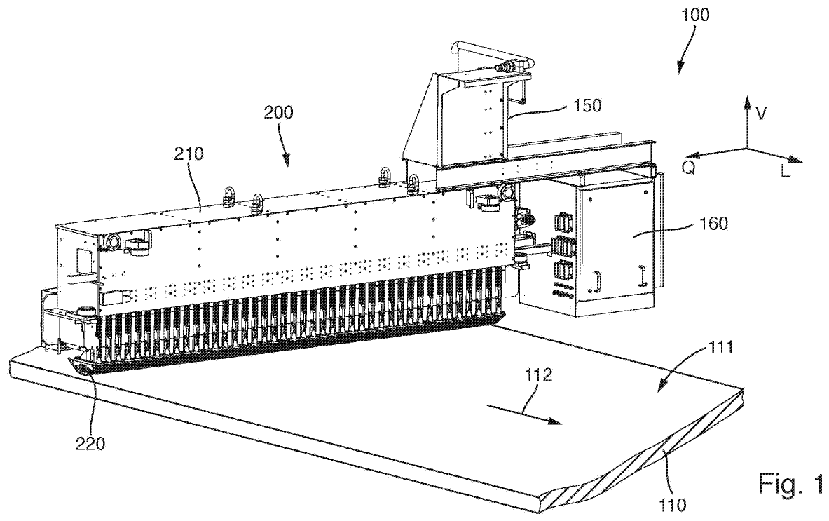

FIG. 1 shows a schematic view of parts of an ultrasonic testing system 100 for non-destructive material testing of test specimens by means of ultrasound. In the example, the test specimen 110 to be tested is a plate which is transported through the ultrasonic testing system in a rolling train of a steel mill in a conveying direction 112 with horizontal orientation on a roller table or the like.

A probe arrangement 200 of the ultrasonic testing system 100 is arranged above the test specimen 110 passing through. This probe arrangement is provided for scanning the test specimen 110 substantially over its entire width in a gap-free manner with the aid of ultrasonic probes and, in the process, for achieving ultrasonic testing in a gap-free manner in the transverse direction (100% surface testing). The probe arrangement forms a so-called surface testing carriage, which can be moved horizontally in the transverse direction between the illustrated testing position above the roller table and a service position lying next to the roller table.

The probe arrangement 200 tests the test specimen 110 from its upper side 111 along a testing direction which runs parallel to the conveying direction 112. The surface test can cover virtually the entire width of the test specimen. The maximum testing width of the probe arrangement corresponds to the sheet width in the transverse direction minus narrow unchecked edge regions, which are usually narrower than 100 mm, for example. For testing the lateral edges of the test specimen which cannot be reached by the surface testing carriage, the ultrasonic testing system has separate edge testing carriages, which are not illustrated here. Also not illustrated are any testing devices for the head or the foot of a sheet passing through, that is to say for the ends of the test specimen, which is elongate in the conveying direction.

The probe arrangement 200 has a base carrier 210 which is relatively narrow in the longitudinal direction L running parallel to the testing direction and extends over the entire width of the test specimen 110 in the transverse direction Q perpendicular thereto. The lateral cladding panels give the base carrier a box-like shape.

Numerous probe holders 220, which are constructed identically to one another, are mounted on the underside of the base carrier 210 facing the test specimen and are carried by the base carrier. They can be adjusted parallel to the vertical direction V in the direction of the test specimen or in the opposite direction. In the example, over 40 identical probe holders 220 are provided.

The probe holders 220 are arranged in a single straight row which extends in the transverse direction Q substantially over the entire width of the test specimen. Each probe holder is suspended on an inherently mobile suspension means which, together with the probe holder carried by it, forms a probe holder assembly which can be exchanged as a whole. In the example, the suspension means comprises a parallelogram holder which permits a limited up and down movement of the probe holder between a lowered testing position and a raised rest position. The suspension means of the probe holders on the parallelogram holders are in each case designed in such a way that probe holders are not mounted rigidly but can be tilted to a limited extent both in the longitudinal direction L and in the transverse direction, thus enabling each of the probe holders to follow any unevennesses in the surface 111 of the specimen to a certain extent, independently of adjacent probe holders.

The ultrasonic testing system 100 has a medium supply device 150 for supplying media (for example a coupling medium (usually water), compressed air, electric current for automation, control signals) and a probe connection box 160 for accommodating the electrical connections for the probes of the probe arrangement.

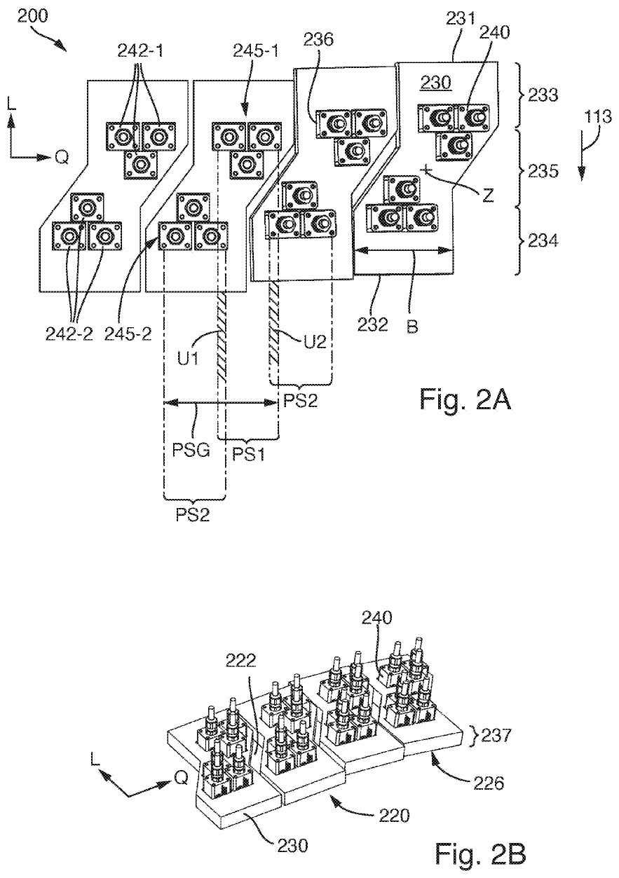

For a further explanation of the construction of the probe arrangement 200, FIGS. 2A and 2B show a plan view and an oblique perspective view, respectively, of components of four probe holders 220 of a probe arrangement, which lie next to one another in a row. On its underside facing the test specimen, each probe holder 220 has a “sliding sole” 230 in the form of a solid plate made from a wear-resistant material, for example from stainless steel with hard metal inserts and/or from a hardened steel material. For testing, the probe holders are fed in downward in the direction of the test specimen in such a way that the sliding soles lie with their contact surfaces 226 facing the test specimen on the surface of the test specimen, a liquid coupling medium (e.g. water) being located in the coupling gap between the probes and the surface of the test specimen. The sliding soles slide on the thin layer of coupling medium when the test specimen moves parallel to the testing direction relative to the probe holder. As a rule, the sliding sole is exchangeably fastened to the underside of a metallic holding frame. The holding frame, not illustrated in FIGS. 2A, 2B, forms a holding structure in which the individual probes are mounted at their intended positions. The region which comes close to the test specimen and has the sliding sole 230 is also referred to as the sliding sole region 237.

There are in each case interspaces 222 between immediately adjacent probe holders, and therefore individual movement of the probe holders relative to one another is possible without mutual collision.

Each of the sliding soles 230 has a substantially S-shaped configuration and extends in the longitudinal direction L between a front edge 231, which leads during testing, and a trailing rear edge 232, which, in the example, extend parallel or substantially parallel to the transverse direction Q.

The one-piece sliding sole can be notionally subdivided into different sections. Adjoining the front edge 231 is a front section 233 of the sliding sole with lateral edges extending parallel to the longitudinal direction. Adjoining the rear edge is a rear section 234 of the sliding sole with lateral edges extending parallel to the longitudinal direction. The front and the rear section are connected via a central section 235 of the sliding sole, the lateral edges of which extend predominantly obliquely with respect to the longitudinal direction and to the transverse direction. An angle between the longitudinal direction and the lateral edges in the central section can be between 30° and 50°, for example.

The shape of the sliding soles 230 or the shape of the probe holder in the sliding sole region 237 thus has no mirror symmetry either with respect to the longitudinal direction L or with respect to the transverse direction Q. On the contrary, the shape may be described such that it is substantially point-symmetrical with respect to a center of symmetry Z located centrally between the front edge and the rear edge. The respective S-shaped sliding soles are interlocked in such a way that, when viewed in the longitudinal direction L, a front section of a sliding sole lies partially in front of or behind the rear section of a sliding sole arranged directly next to it.

Each sliding sole has, both at the transition between the front section and the central section and at the transition between the central section and the rear section, in each case an aperture 236 which passes through from the contact surface provided for signal transmission contact with the test specimen to the inside or upper side and is dimensioned in such a way that one or more probes (in the example in each case three probes) fit into the aperture with little lateral clearance.

In the exemplary embodiment, three separate probes 240, each having a substantially rectangular basic shape, are located in each of the apertures. Each individual probe has an effective testing width, measured in the transverse direction Q, which is somewhat smaller than the width, visible in the illustrations, of the probe between the side surfaces. The three probes of a probe group are mounted in two planes offset with respect to one another in the longitudinal direction L. In the first probe group 242-1, which is located at the transition between the front section 233 and the central section 235, there are two adjacent probes closer to the front edge. The testing gap formed therebetween is covered by the third probe, which is located centrally behind the gap, offset in the longitudinal direction L with respect to the two leading probes. In the case of the second probe group 242-2, which is arranged at the transition between the central section 235 and the rear section 234, there is an arrangement which is point-symmetrical with respect thereto.

The first probe group 242-1 defines a first probe region 245-1, while the second probe group 242-2 defines a second probe region 245-2, which is arranged offset with respect to the first probe region 245-1 both in the longitudinal direction L and in the transverse direction Q.

If the test specimen 110 is moved in accordance with the longitudinal direction L in the testing direction 113 in relation to the probe arrangement 200, then the probes of the first probe region 245-1 scan a first testing track PS1 in a gap-free manner in the transverse direction Q, while the probes of the second probe region 245-2 scan a second testing track PS2 in a gap-free manner in the transverse direction.

A special feature of the exemplary embodiment now consists in how the probe regions of the individual probe holders are arranged relative to one another. The first testing track PSI covered by the first probe region 245-1 of a probe holder 220 overlaps on one side with the second testing track PS2, which is covered by the second probe region 245-2 of the same probe holder during testing. The overlap occurs within a first overlap region U1 in such a way that there is no testing gap between the first testing track and the second testing track and also no region of very different testing sensitivity. On the second side, opposite the first side, of the first testing track PS1, the latter overlaps with a second testing track PS2, which is covered by the second probe region of the directly adjacent probe holder. This overlap exists in a second overlap region U2. The width of the overlap regions U1, U2 in the transverse direction is selected in such a way that there is sufficient overlap in all possible relative positions between directly adjacent probe holders. This results, overall, in testing of the test specimen in a gap-free manner in the transverse direction Q over the entire width covered by probe holders.

The whole can also be described in this way. The first and the second testing track P51, PS2 of the probe regions 245-1, 245-2 of a probe holder 220 overlap in a first overlap region U1 and thereby form an overall testing track PSG of the probes accommodated in this probe holder. The width of this overall testing track, that is to say the overall testing width of a probe holder, is greater than the width B of the probe holder, measured in the transverse direction, at its widest point.

In the previous example, three mutually identical probes are provided for each probe region. This is not mandatory. It is also possible to provide more or fewer probes per probe region, for example just one single probe per probe region.

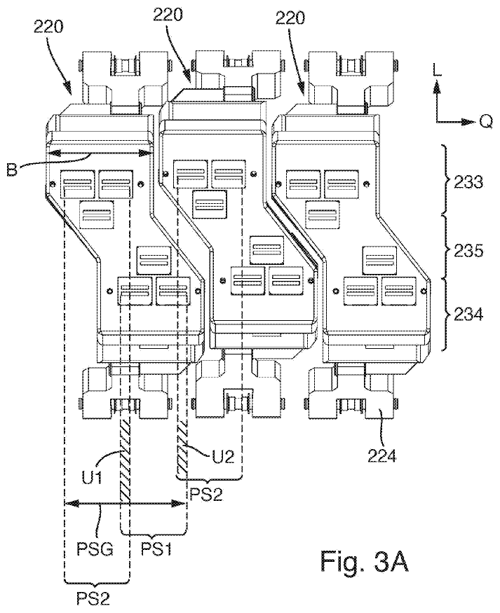

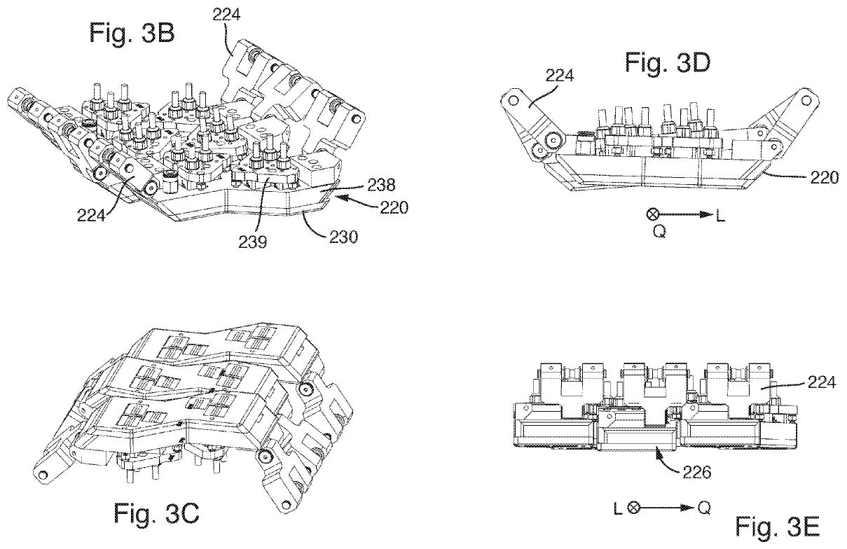

Another embodiment will now be explained with reference to FIGS. 3A to 3E. The figures each show three probe holders, which are situated directly next to one another, of a probe arrangement which, in a straight row next to one another, has many such probe holders, for example 30 or more or 40 or more. For reasons of clarity, individual elements or assemblies are designated by the same reference signs as in FIGS. 1 and 2.

FIG. 3A shows a plan view of the undersides or contact surfaces 226, which are to face the test specimen, of three probe holders 220 of a probe arrangement lying next to one another, FIG. 3B shows an oblique perspective view of the probe holders from above, FIG. 3C shows an oblique perspective view of the probe holders from below, FIG. 3D shows a side view of the group of probe holders with a viewing direction parallel to the transverse direction, and FIG. 3E shows a front view of the three probe holders with a viewing direction parallel to the longitudinal direction of the probe holders.

In FIG. 3A, the already described shape of the probe holders in the sliding zone region with the mutually offset front sections 233 and rear sections 234 and the obliquely positioned central regions 235 can be clearly seen. The figures also illustrate the individual degrees of freedom of movement of the probe holders. Thus, for example, the central probe holder 220 is offset slightly forward or rearward in the longitudinal direction L relative to the outer probe holders of the group shown. This freedom of movement in the longitudinal direction results, inter alia, from the fact that each probe holder is articulated at the front and rear to Y-shaped bearing elements 224, the pivot axes of which extend substantially parallel to the transverse direction Q of the probe arrangement. As a result, it is possible within certain limits to rock the probe holder in the longitudinal direction and, associated therewith, to tilt or obliquely position the probe holder. Tilting possibilities in the transverse direction Q are likewise provided by the design. The mutual offset of the probe holders shown with respect to one another leads not only to the longitudinal offset shown in FIG. 3A but also to the slight differences in height of the contact surfaces 226 with respect to the base carrier, said differences being clearly apparent in FIG. 3E. As a result, the probe arrangement is adaptable to surface unevennesses of the test specimen. It can also be clearly seen in FIG. 3A that the relative movement of the probe holders in the longitudinal direction L is possible despite the mutual offset of the front and the rear section of the probe holders since corresponding clearance spaces result from the obliquely extending central section, thus allowing relative displacements without mutual collision of the probe holders.

The construction of a probe holder can be seen particularly well in FIG. 3B. The probe holder 220 has the sliding sole 230 on the side facing the test specimen. Said sliding sole is fastened to the underside of a mechanically stable holding frame 238, which accommodates the outer shape of the sliding sole in the sliding zone region. The holding frame serves for the positionally correct fastening of the probes 240 in the probe holder. The probes themselves are each mounted in groups of three on a triangular mounting frame 239, thus enabling them to be installed in the probe holder or removed together as a probe group.

For the conditions of the individual testing tracks PS1, PS2 of the probe holders and their mutual overlap in the overlap regions U1, U2, attention is drawn to the description in conjunction with FIG. 2A.

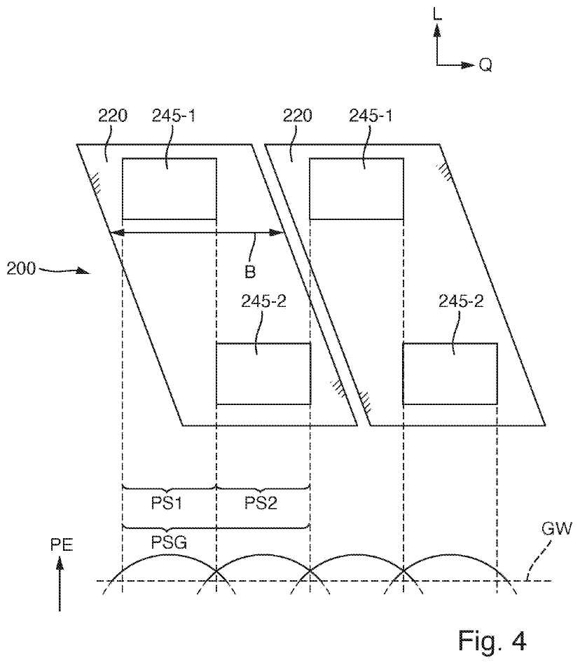

A probe arrangement 200 is described with reference to the schematic FIG. 4, in which the probe regions 245-1 and 245-2 of the probe holders 220 are in each case arranged offset with respect to one another in the transverse direction in such a way that the first testing track PS1 covered by a first probe region 245-1 of a probe holder 220 adjoins the second testing track PS2, which is covered by the second probe region 245-2 of the same probe holder 200, without overlapping one another but nevertheless in a gap-free manner. As a departure from the previous exemplary embodiment, the shape of the probe holders 220 in the sliding zone region illustrated is not S-shaped but parallelogram-shaped and oriented in a continuously oblique manner with respect to the longitudinal direction L and to the transverse direction Q.

In the lower part of FIG. 4, the profile of the testing sensitivity PE in the transverse direction Q is shown schematically for each of the probe regions. It can be seen that the testing sensitivity is relatively high in each case in the central region of a testing track, while it declines toward the lateral edges of the testing track. The conditions are illustrated in a highly schematic manner here. Although there is a slight drop in testing sensitivity in the transition region to the adjacent testing track, no testing gaps are formed in the region between the testing tracks, which merge into one another in a gap-free manner, since, even in the region of locally minimum testing sensitivity directly at the transition between the testing tracks, the local testing sensitivity is above the limit value GW specified for the testing task which is intended here. Thus, the testing arrangement 200 can be used to reliably detect all the discontinuities or reflectors sought in this testing, even in the regions directly in the transition between adjacent testing tracks. This applies to all relative positions between the probe holders, which are movable relative to one another.

The first testing track PS1 and the second testing track PS2 of the probe regions 245-1, 245-2 of a probe holder 220 merge into one another in a gap-free manner or without testing gaps and thereby form an overall testing track PSG of the probes accommodated in this probe holder. The width of this overall testing track, that is to say the overall testing width of a probe holder, is greater than the width B of the probe holder, measured in the transverse direction, at its widest point.

The concept, presented in this application, of a novel design of probe holders of a probe arrangement can be implemented with different types of probes. In many exemplary embodiments, the probes are “transmit-receive probes” or TR probes, in which the sound-emitting ultrasonic transducers and the sound-receiving ultrasonic transducers are components which are separate from one another and are combined in one probe. Such TR probes can be used in different designs, that is to say, inter alia, with different numbers of transmitting elements and receiving elements. The notation TₓR_{y} can be used for the configuration of the probes, for example, where x indicates the number of transmitter elements (transmitters) and y the number of receiver elements (receivers). The following combinations are possible, for example: T1R1, T1R3 or T1R4. In this case, T1R1 correspondingly means that exactly one receiving element is assigned to an individual transmitting element in the probe. In the case of the combination T1R4, there is a single transmitting element per probe, to which 4 separate receiver elements are assigned. The transmitting element extends over the entire width, the four receiver elements are arranged directly next to one another and then substantially cover the width of the transmitting element. The probes can have different testing track widths. As a rule, the testing track widths in the case of type T1R3 or T1R4 are greater than in the case of type T1R1, they can be, for example, 50 mm, while a testing track width of 25 mm can be provided in the case of T1R1.

The transmitting and receiving elements of a probe are each located in a common probe housing. The ultrasonic transducers generally comprise piezoelectric elements. At the edges of a piezoelectric element, the abovementioned drop in the testing sensitivity between the individual testing tracks occurs on account of physical effects. This dip in sensitivity can have the effect that smaller reflectors (e.g. defects) in the vicinity of the probe or at greater depths cannot be detected with sufficient reliability in this region between the testing tracks. If it is not necessary to detect such defects in the testing task, the slight drop in the testing sensitivity in the transition region has no practical effects. An arrangement according to FIG. 4 can be selected. If there is a desire to keep the drop in the testing sensitivity relatively low or to avoid it to a large extent, the variant with mutual overlapping of the testing tracks in accordance with the previously mentioned exemplary embodiment can be selected. In each of the cases, however, testing in a gap-free manner, i.e. testing without a testing gap, is ensured because the testing sensitivity is above the minimum testing sensitivity specified for the testing task, even in the transition regions.

1.-10. (canceled)

11. A probe arrangement for a testing system for non-destructive material testing involving relative movement of a test specimen with respect to the probe arrangement along a testing direction, comprising:
a base carrier, which base carrier defines a longitudinal direction, which can be oriented parallel to the testing direction, and a transverse direction, which can be oriented perpendicularly to the testing direction; and
a plurality of probe holders carried by the base holder, which probe holders are arranged next to one another in a row in the transverse direction, wherein
each probe holder has a first probe region, which is equipped with at least one first probe, and a second probe region, which is equipped with at least one second probe,
each of the probe regions defines an effective testing width in such a way that, during relative movement of the test specimen with respect to the probe arrangement along the testing direction through the probe region, a testing track having the effective testing width can be tested in a gap-free manner, and
the first probe region and the second probe region of a probe holder are arranged so as to be offset with respect to one another parallel to the longitudinal direction and parallel to the transverse direction in such a way that:
a first testing track covered by the first probe region of a probe holder merges on one side in a gap-free manner into a second testing track covered by the second probe region of the same probe holder, and merges on an opposite side in a gap-free manner into a second testing track covered by a second probe region of a directly adjacent probe holder.

12. The probe arrangement as claimed in claim 11, wherein
the first testing track covered by the first probe region of a probe holder overlaps on one side with the second testing track covered by the second probe region of the same probe holder in a first overlap region and overlaps on the opposite side with the second testing track covered by a second probe region of the directly adjacent probe holder in a second overlap region.

13. The probe arrangement as claimed in claim 11, wherein
the probe holders are mounted on the base carrier so as to be movable individually, wherein each of the probe holders is mounted so as to be tiltable to a limited extent in the longitudinal direction and in the transverse direction.

14. The probe arrangement as claimed in claim 11, wherein
each of the probe holders has, in a sliding sole region which is to face the test specimen, a shape which has a front section which leads during testing and a rear section which trails during testing, and
wherein the front and the rear sections are offset with respect to one another in the longitudinal direction and in the transverse direction.

15. The probe arrangement as claimed in claim 11, wherein
each of the probe holders has, in a sliding sole region which is to face the test specimen, a shape which extends obliquely with respect to the longitudinal direction and to the transverse direction, in some section or sections or over its entire length.

16. The probe arrangement as claimed in claim 14, wherein
each of the probe holders has a central section located between the front section and the rear section, wherein
the front and the rear section are offset with respect to one another in the longitudinal direction and in the transverse direction, and
the central section extends obliquely with respect to the longitudinal direction and to the transverse direction.

17. The probe arrangement as claimed in claim 11, wherein
each of the probe holders has, in a sliding sole region which is to face the test specimen, a shape which is substantially point-symmetrical with respect to a center of symmetry located centrally between a front edge and a rear edge and has no mirror symmetry either with respect to the longitudinal direction or with respect to the transverse direction.

18. The probe arrangement as claimed in claim 11, wherein
the first testing track and the second testing track of the probe regions of a probe holder merge into one another in a gap-free manner and thereby form an overall testing track of the probes accommodated in this probe holder, wherein a width of said overall testing track is greater than the width of the probe holder, measured in the transverse direction, at its widest point.

19. The probe arrangement as claimed in claim 11, wherein
in each of the probe regions of the probe holder, a probe group is arranged having a plurality of probes which are arranged offset with respect to one another in the longitudinal direction and in the transverse direction such that an effective testing width of the probe region is greater than an individual testing width of each of the probes.

20. A testing system for non-destructive material testing, comprising:
only a single probe arrangement, the non-destructive material testing involving relative movement of a test specimen with respect to the probe arrangement, wherein the probe arrangement comprises
a base carrier, which base carrier defines a longitudinal direction, which can be oriented parallel to the testing direction, and a transverse direction, which can be oriented perpendicularly to the testing direction; and
a plurality of probe holders carried by the base carrier, which probe holders are arranged next to one another in a row in the transverse direction, wherein
each probe holder has a first probe region, which is equipped with at least one first probe, and a second probe region, which is equipped with at least one second probe,
each of the probe regions defines an effective testing width in such a way that, during relative movement of the test specimen with respect to the probe arrangement along the testing direction through the probe region, a testing track having the effective testing width can be tested in a gap-free manner, and
the first probe region and the second probe region of a probe holder are arranged so as to be offset with respect to one another parallel to the longitudinal direction and parallel to the transverse direction in such a way that:
a first testing track covered by the first probe region of a probe holder merges on one side in a gap-free manner into a second testing track covered by the second probe region of the same probe holder, and merges on an opposite side in a gap-free manner into a second testing track covered by a second probe region of a directly adjacent probe holder.
